(19) United States
(12) Patent Application Publication
(10) Pub. No.: US 2012/0253525 A1
(43) Pub. Date: Oct. 4, 2012

(54) AIR-CONDITIONING CONTROLLING SYSTEM

(75) Inventor: Hitomi Suzuki, Tokyo (JP)

(73) Assignee: YAMATAKE CORPORATION, Tokyo (JP)

(21) Appl. No.: 13/417,437

(22) Filed: Mar. 12, 2012

(30) Foreign Application Priority Data
Mar. 31, 2011 (JP) 2011-078997

(51) Int. Cl. G05D 23/19

(52) U.S. Cl. 700/277

(57) ABSTRACT

An air-conditioning controlling system having a controlling device controlling the operation of air-conditioning equipment based on setting information that has been set up in advance, and including an operating terminal wherein setting information can be changed by an occupant of an applicable area of the air-conditioning equipment, connected to the controlling device through a communication circuit, wherein the occupant is able to check what type of control operation is scheduled, prior to changing a setting for the applicable equipment, through scheduled operating information for the future for the specified applicable equipment being sent to the operating terminal that is operated by the occupant, thus enabling the occupant to consider individual countermeasures rather than changing the settings easily, not only making it possible to maintain the energy conservation effect of the air-conditioning controlling system as a whole, but also making it possible to increase the energy conservation awareness of the occupant.

### CROSS REFERENCE TO RELATED APPLICATIONS

The present application claims priority under 35 U.S.C. §119 to Japanese Patent Application No. 2011-078997, filed Mar. 31, 2011, which is incorporated herein by reference.

### FIELD OF TECHNOLOGY

The present invention relates to an air-conditioning controlling system for controlling and monitoring air-conditioning equipment in factories, building facilities, and the like.

### BACKGROUND

Operators who maintain and control air-conditioning equipment within buildings in building facilities, and the like, monitor the operating state, and the like, while viewing current value data and trend graphs of air-conditioning equipment displayed on controlling devices in a centralized control room.

For example, Japanese Unexamined Patent Application Publication 2003-240318 discloses a monitoring device wherein information for the operating state of facilities equipment; temperature settings, and the occurrence of faults are provided as a web server, and software that has a browser function is used to enable monitoring from a terminal device, wherein the operating state, and the temperature settings for the facilities equipment can be controlled from the terminal device. The application of this monitoring device to a device for monitoring air-conditioning equipment within a building makes it possible for the occupants to use terminal devices to change temperature settings at will, depending on the current temperature and their physical experience.

However, if changes to settings are permitted freely depending on the current temperature and the physical experience, then there will be a tendency for setting changes to be made by occupants who lack awareness of energy conservation. On the other hand, while those occupants who are mindful of energy conservation may take countermeasures, such as adjusting their individual clothing, without depending on the air-conditioning setting conditions when the settings cannot be changed easily, these countermeasures are performed only on the level of the individual, and at present there is no sharing of information between the occupants.

However, in the conventional controlling device there is a problem in that, when, in the conventional controlling device, it is possible to control the operating state and the temperature settings of the air-conditioning equipment from terminal devices, the energy conservation effects are not as high as expected because the operating state and the temperature settings of the air-conditioning equipment are changed continuously from terminal devices based on the physical experience of the occupants, despite the performance of control operations that would have excellent effects in energy conservation such as a controlling device that performs controlling and monitoring changing and optimizing the settings for the operating parameters based on weather forecast information, and the like. Moreover, there is a problem in that the occupants do not know how the control is actually performed, do not know how the changes they have made will be implemented, and are unable to anticipate how control will be performed thereafter (in the future), and so does not lead to any large improvements in energy conservation awareness.

The present invention is to solve the problem areas such as set forth above, and the object thereof is to provide an air-conditioning controlling system wherein the terminal devices operated by the occupants are notified of operating information scheduled in the future for specified air-conditioning equipment.

### SUMMARY

In order to achieve the object set forth above, an example of the present invention is an air-conditioning controlling system having a controlling device for controlling the operation of air-conditioning equipment based on this setting information that is set up in advance, and an operating terminal wherein setting information can be changed by an occupant that is resident in an applicable area of the air-conditioning equipment, connected through a communication circuit to the controlling device, where the operating terminal includes a schedule information requesting portion for requesting, from the controlling device, setting information for a specified future date set for the air-conditioning equipment of the applicable area through an occupant specifying the applicable area and the future date; and the controlling device has a setting information controlling portion which, upon receipt of a request for setting information for a future date from a schedule information requesting portion of an operating terminal, specifies the air-conditioning equipment corresponding to the specified applicable area, and sends, to the operating terminal, the forecasted weather and anticipated outside temperature on the specified future date and, as scheduled operating information, at least the temperature settings and the controlling mode from the setting information that is set for the specified future date for the specified air-conditioning equipment.

Moreover, in examples of the present invention, the operating terminal further includes a current information requesting portion for requesting, from the controlling device, current setting information for the air-conditioning equipment for the applicable area, through an occupant specifying the applicable area; and the controlling device further has an operating information controlling portion for specifying the air-conditioning equipment corresponding to the specified applicable area upon receipt of a request for current setting information from a current information requesting portion of an operating terminal, and for sending, to the operating terminal, at least the current operating state and the type of operation for the specified air-conditioning equipment, as current operating information, together with the current weather and outside temperature.

Further, when sending the scheduled operating information to the operating terminal, the setting information controlling portion of the controlling device, can, upon receipt of a request for setting information for a future date from a schedule information requesting portion of an operating terminal, compare the scheduled operating information for the future date to setting information for past dates, and if there exists setting information for a past date that matches, at least in part, information included in the scheduled operating information, adds, to the scheduled operating information for the future date, information including at least the temperature settings and the controlling mode included in the setting information for the past date, as operating information for the past date.

Furthermore, in examples of the present invention, the operating terminal further has an individual countermeasure information controlling portion for sending to the controlling device, as individual countermeasure information, information including a date of inputting, an applicable area, and a countermeasure in response to the environment through the occupant inputting an applicable area and a countermeasure in response to the environment taken individually in the applicable area; and the controlling device further includes an individual countermeasure information storing portion for specifying the air-conditioning equipment corresponding to the applicable area included in the individual countermeasure information and for storing the individual countermeasure information in relation to the specified air-conditioning equipment when individual countermeasure information has been received from the individual countermeasure information controlling portion of an operating terminal; where when the setting information controlling portion sends operating information for a past date to the operating terminal, the setting information controlling portion searches the individual countermeasure information stored in the individual countermeasure information storing portion, and if individual countermeasure information exists for the air-conditioning equipment of the applicable area on a past date, further adds, to the operating information for the past date, the countermeasure for the environment in that individual countermeasure information.

The examples of the present invention provide notification, to an operating terminal operated by an occupant, of scheduled operating information for the future for specified air-conditioning equipment, thereby making it possible for the occupant to confirm, prior to changing a setting for the air-conditioning equipment, the types of control operations that are scheduled, thus enabling the occupant to consider personal countermeasures rather than changing settings easily, not only making possible to maintain the energy conservation effects of the air-conditioning controlling system as a whole, but also making it possible to increase the energy conservation awareness of the occupants.

### BRIEF DESCRIPTION OF THE DRAWINGS

FIG. 1 is a diagram illustrating schematically functional blocks and a system structure for an air-conditioning controlling system according to an example of the present invention.

FIG. 2 is a table showing details of control of control modes in an air-conditioning controlling system.

FIG. 3 is a diagram illustrating an example of a display screen for setting information, of a future date, in the example.

FIG. 4 is a diagram showing an example of a display screen of current setting information in the example.

FIG. 5 is a table showing the current air-conditioning operating state and the types of control in an air-conditioning system according to the example.

FIG. 6 is a diagram showing an example of a display screen for setting information of a future date, and a display screen for similar setting information of a past date.

FIG. 7 is a diagram illustrating schematically functional blocks and a system structure for an air-conditioning controlling system according to another example.

FIG. 8 is a diagram showing an example of a display screen for setting information of a future date, and a display screen for similar setting information of a past date, in the example.

### DETAILED DESCRIPTION

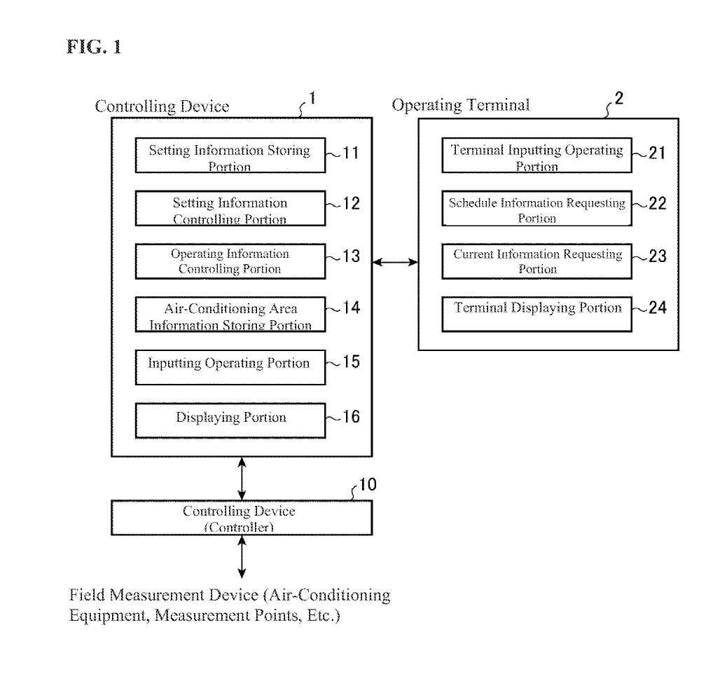

FIG. 1 is a diagram illustrating schematically functional blocks and a system structure for an air-conditioning controlling system according to an example of the present invention. This air-conditioning controlling system is structured from a controlling device 1 and operating terminals 2 that are connected by a communication circuit to the controlling device 1.

The controlling device 1 is connected by a communication circuit to a controlling device (controller) 10 for performing control of the air-conditioning equipment that is installed within an area, through a plurality of controlling methods that have been set up in advance, where normally control operations are performed according to one of the plurality of controlling methods based on setting information that has been set up in advance. Note that as the plurality of controlling methods there are, for example, schedule control, optimize startup/shutdown control, electric power conservation operating control, outside air cooling/heating control, electric power demand control, and the like, where the control operations for the air-conditioning equipment are performed according to one or more of these controlling methods.

The operating terminal 2 is provided with a terminal inputting operating portion 21 that enables operation and inputting by the occupant, and is provided with a schedule information requesting portion 22 for requesting, from the controlling device 1, setting information with a specified future date, set up for the air-conditioning equipment, through specifying, using the terminal inputting operating portion 21, the air-conditioning equipment and the future date. Moreover, it is further provided with a current information requesting portion 23 for the terminal inputting operating portion 21 to request current setting information from the controlling device 1, and a terminal displaying portion 24 for displaying various types of information, and the like.

The controlling device 1 is provided with a setting information storing portion 11 for storing setting information that has been set up in advance based on the plurality of controlling methods for the individual air-conditioning equipment, a setting information controlling portion 12 for providing notification of the scheduled operating information to the operating terminal 2 when a request has been received from the operating terminal 2 for setting information of a future date, an operating information controlling portion 13 for providing notification of the current operating information to the operating terminal 2 when a request has been received from the operating terminal 2 for the current setting information, and an air-conditioning area information storing portion 14 for storing the applicable areas for the individual air-conditioning equipment. Moreover, it is also provided with an inputting operating portion 15 to enable operation and inputting, and a displaying portion 16 for displaying a monitoring screen and various types of information.

Here the respective functions of the setting information storing portion 11, the setting information controlling portion 12, and the operating information controlling portion 13 of the controlling device 1 will be explained in detail.

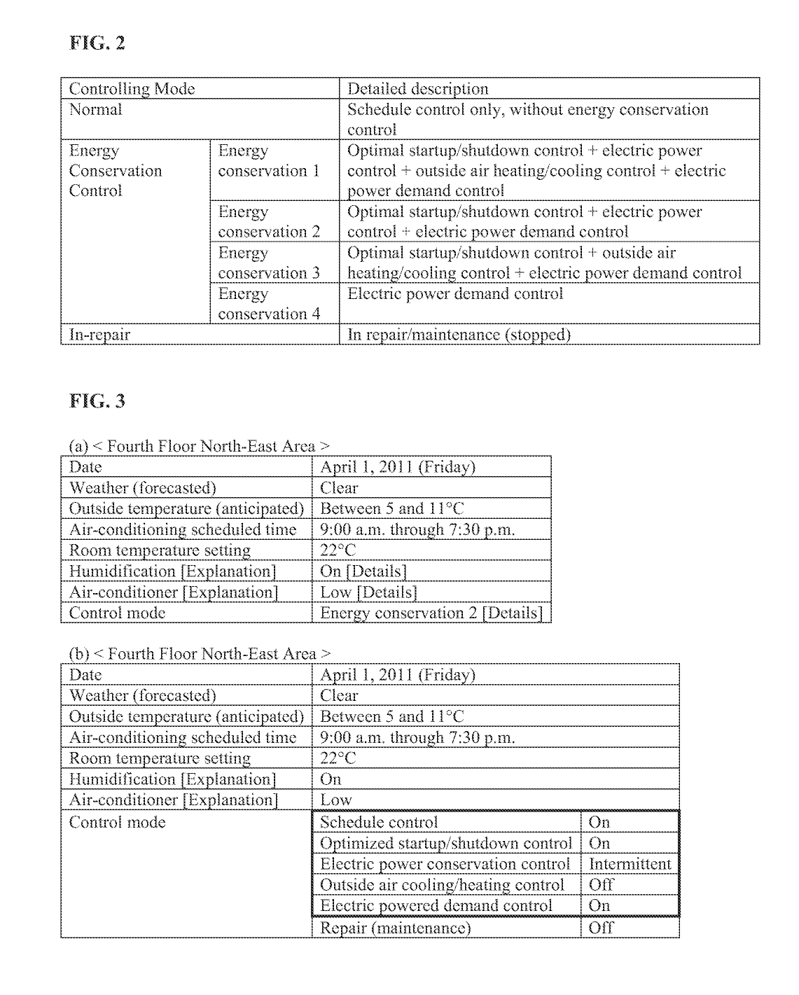

The setting information storing portion 11 stores, at least, dates, weather (forecasts), outside air temperatures (anticipated), names (or areas, numbers, or the like) of air-conditioning equipment, and setting conditions (air-conditioning scheduled times, temperature settings, controlling modes, and the like) for the air-conditioning equipment. Here the controlling modes, as illustrated in FIG. 2, indicate which of the controlling methods, of the plurality of controlling methods, can be used for the control operations.

Upon receipt of a request for setting information of a future date from a schedule information requesting portion 22 of an operating terminal 2, the setting information controlling portion 12 provides notification to the operating terminal 2 of, as scheduled operating information, information including at least the temperature settings and operating mode, of the setting information that is set up for a future date for the specified air-conditioning equipment, together with the forecasted weather and anticipated outside temperature on the specified future date.

Upon receipt of a request for the current setting information from a current information requesting portion 23 of an operating terminal 2, the operating information controlling portion 13 provides notification to the operating terminal 2 of, as the current operating information, information including at least the current operating state and type of control for the specified air-conditioning equipment, together with the current weather and outside temperature.

The specific processes in the air-conditioning system by the controlling device 1 and the operating terminal 2 will be explained next.

When, for example, an occupant that is resident in an applicable area of the air-conditioning equipment wishes to check the settings for the air-conditioning, equipment for any given applicable area for the following day and there is a request for setting information, from a terminal inputting operating portion 21 of an operating terminal 2 to the controlling device 1 specifying the applicable area and the date of the following day, the setting information controlling portion 12 of the controlling device 1 specifies the air-conditioning equipment corresponding to the specified applicable area, from the air-conditioning area information storing portion 114, and obtains, from the setting information storing portion 11, the setting information for the following day for the specified air-conditioning equipment, and provides notification thereof to the operating terminal 2. Given this, the result of the notification is displayed on the terminal displaying portion 24 of the operating terminal 2.

FIG. 3 is an example of a display screen for the setup information of a future date, sent to the operating terminal 2 in this way. The screen shown in FIG. 3(a) includes, in addition to the forecasted weather and the anticipated outside temperature for the following day (Apr. 1, 2011), the scheduled time of operation of the air-conditioner, the temperature setting, humidification information, and the air flow rate and the controlling mode for the air conditioner, regarding the air-conditioning equipment for the “Fourth Floor, North-East area.” Note that the positions marked as “Explanation” and “Details” in the figure can be touched, clicked, or the like, to display an explanation regarding the item or to display more detailed information. Here the “Details” regarding the controlling mode can be touched, clicked, or the like, to display the table of details of control, shown in FIG. 2, or to display a screen such as shown in FIG. 3(b). Moreover, if there is room in the display area, the screen shown in FIG. 3(b) may be displayed from the start. Note that the displays for “Explanation” and “Details” are omitted in the examples of display screens, below.

Through the information that is displayed, as illustrated in FIG. 3, the occupant can check the forecasted weather and the anticipated outside temperature for the following day (the future date), and can also check the details of settings such as the temperature settings and the controlling mode, and the like, for the air-conditioning equipment of any given applicable area, thus making it possible to take countermeasures such as considering the clothing to wear for the following day, making it possible to maintain the energy conservation effects of the air-conditioning controlling system as a whole, and making it possible to improve the energy conservation awareness of the occupants.

Additionally, if the occupant wishes to check the current settings for the air-conditioning equipment in the area wherein he or she is currently resident, and there is a request to the controlling device 1 from a terminal inputting operating portion 21 of an operating terminal 2 for the current air-conditioning equipment setting information, specifying an applicable area, the operating information controlling portion 13 of the controlling device 1 specifies the air-conditioning equipment corresponding to the applicable area, specified from the air-conditioning area information storing portion 14, to provide notification, to the operating terminal 2, of the current setting information for the specified air-conditioning equipment.

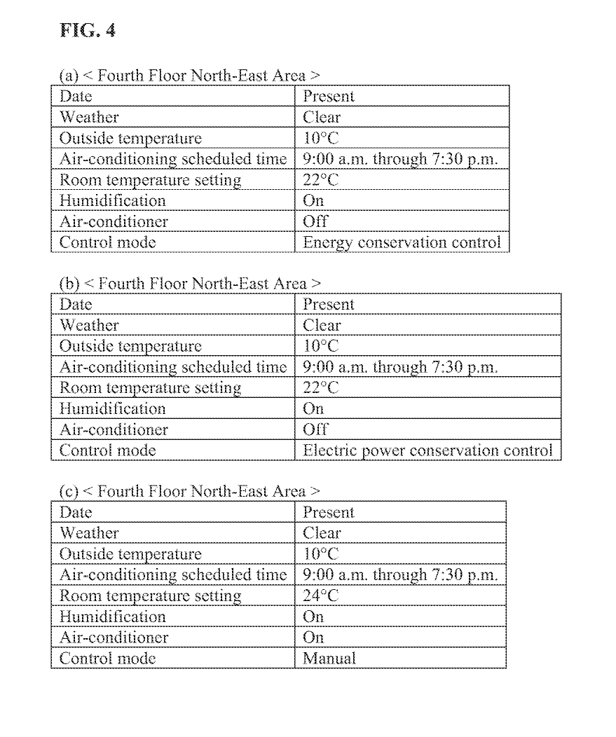

FIG. 4 is an example of a display screen for the current setting information that has been sent in this way to the operating terminal 2. The screen illustrated in FIG. 4 includes the current weather and outside temperature, and also the scheduled time for air-conditioning, the temperature settings, humidification information, and the operating state of the air-conditioner (whether it is ON or OFF), for the air-conditioning equipment for the “Fourth Floor, North-East area.” As illustrated in FIG. 5, here the type of control is the controlling method for the current operating state of the air-conditioning equipment is displayed, or the cause factor (Manual Operation, in-Repair, Fault (trouble), or the like) is displayed. For example, in FIG. 4(a) it can be seen that the air conditioner is OFF due to “Energy Conservation Control” (referencing FIG. 2), and in FIG. 4(b) it can be seen that the air-conditioning equipment is OFF due to “Electric Power Control” within the energy conservation control. Moreover, it can be seen in FIG. 4(c) that the temperature setting has been set to 24° C. “Manually,” and the air-conditioning has been turned ON.

In this way, through displaying information such as illustrated in FIG. 4, when the occupant that is resident in an applicable area of the air-conditioning equipment wishes, for example, to change the temperature setting because he/she feels slightly chilly, or when the occupant wishes to start up (turn ON) air-conditioning equipment that is stopped, the occupant is able to check the current temperature setting and operating state, and the like, prior to changing the setting, making it possible for the occupant to take individual countermeasures, such as putting on a coat, without changing the settings easily when, for example, the air-conditioning equipment is stopped due to energy conserving operations, thus not only making it possible to maintain the energy conservation effect of the air-conditioning controlling system as a whole, but also increasing the energy conservation awareness of the occupant.

The functional blocks and schematic system structure of the air-conditioning controlling system according to another example of the present invention are identical to those of FIG. 1. The example is different from the above only in the processing details of the setting information controlling portion 12 in the controlling device 1, and because the other functions and structures are identical to those above, explanations thereof are omitted. Note that the setting information controlling portion in this example is explained as a setting information controlling portion 12′.

Upon receipt, from a schedule information requesting portion 22 of an operating terminal 2, for setting information of a future date, the setting information controlling portion 12, when providing notification to the operating terminal 2 of the forecasted weather, anticipated outside temperature, and scheduled operating information such as the temperature settings, controlling mode, and the like, with the specified future date, compares the scheduled operating information for a future date, which is stored in the setting information storing portion 11, to setting information of past dates, and if there exists setting information of a past date wherein at least some of the information matches, then information including at least the temperature settings and the controlling mode, of the setting information of the past date, is sent, as operating information of a past date, in addition to the scheduled operating information of a future date.

For example, if an occupant wishes to check the details of settings for the air-conditioning equipment for the “Fourth Floor, North-East area” for Apr. 1, 2011, and there is a request, to the controlling device 1, from a terminal inputting operating portion 21 of an operating terminal 2 for information specifying the applicable area (Fourth Floor, North-East area) and date, then the setting information controlling portion 12 of the controlling device 1 specifies the air-conditioning equipment corresponding to the Fourth Floor North-East area, from the air-conditioning area information storing portion 14, to obtain, from the setting information storing portion 11, the setting information for April 1 for the specified air-conditioning equipment, and also obtains setting information from past dates (March 29, March 25, . . . ) matching at least some of the scheduled operating information for April 1, such as the temperature settings, the operating mode, or the like, and sends, to the operating terminal 2, information including at least the temperature settings and the operating mode, of the setting information for March 29, March 25, . . . , in a form wherein it is added to the scheduled operating information for the specified date of April 1.

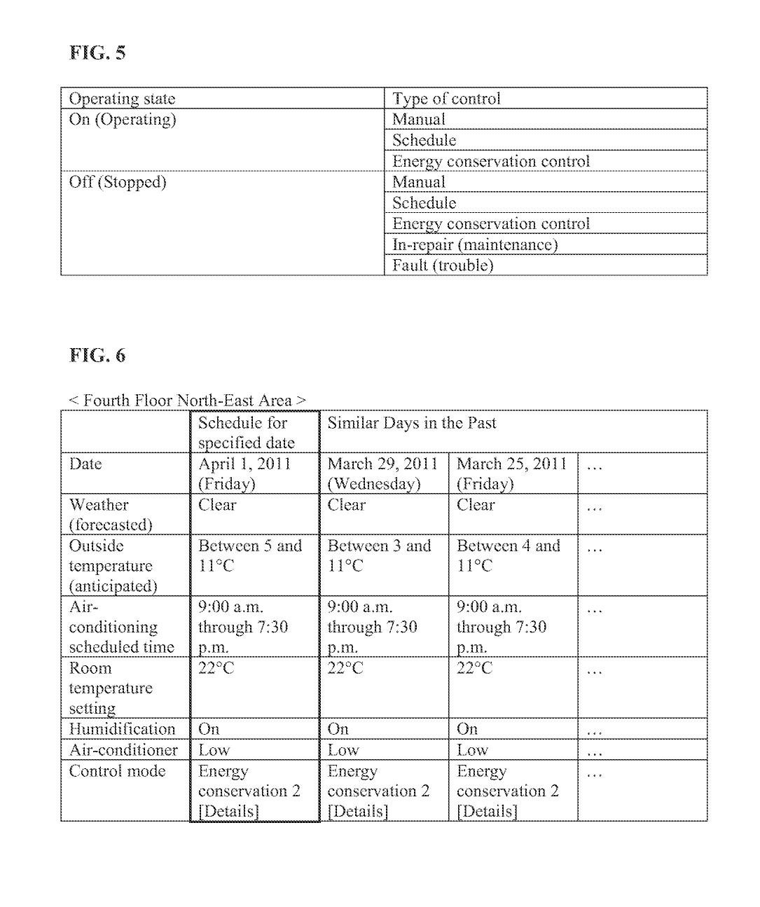

FIG. 6 is a diagram illustrating one example of a display screen for setting information for a future date and similar setting information for past dates, sent to the operating terminal 2 in this way.

Displaying the information such as illustrated in FIG. 6, in this way, makes it possible for the occupant to check information for days on which the same settings have been made in the past, in addition to checking the scheduled operating information for a future date for the air-conditioning equipment in any given applicable area, thus making it possible to recall the state on similar days in the past, to enable individual countermeasures such as were taken, not only making it possible to maintain the energy conservation effect of the air-conditioning controlling system as a whole, but also making it possible to increase the energy conservation awareness of the occupants.

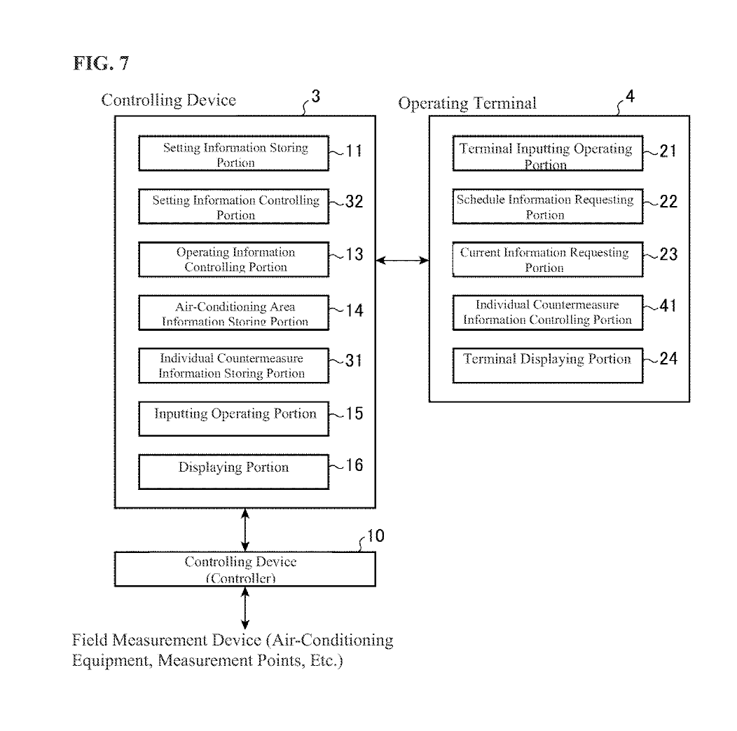

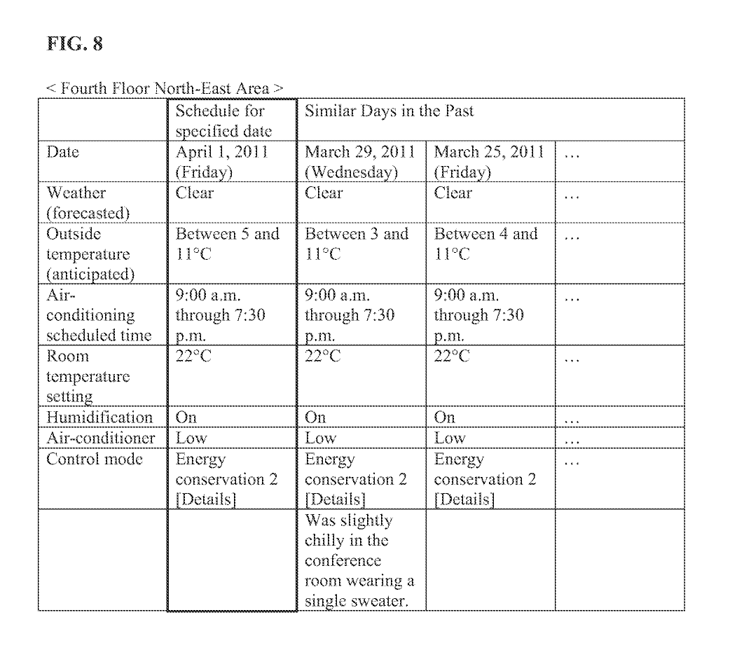

FIG. 7 is a diagram illustrating schematically functional blocks and a system structure for an air-conditioning controlling system according to a further example of the present invention. This air-conditioning controlling system is structured from a controlling device 3 and operating terminals 4 that are connected by a communication circuit to the controlling device 3.

The controlling device 3 is provided with an individual countermeasure information storing portion 31 in addition to the controlling device from the above examples, and, additionally, the processes in the setting information controlling portion 32 are different from those in the setting information controlling portion 12 for the and the setting information controlling portion 12′ from the above examples, but the other functions and structures are identical to those above, so explanations thereof will be omitted.

Note that the operating terminal 4 is different from those in the above examples only in the provision of the individual countermeasure information controlling portion 41 in addition to the operating terminal 2 in the above examples, and the other functions and structures are identical to those above, so explanations thereof will be omitted.

Given this, the individual countermeasure information controlling portion 41 in the operating terminal 4 sends, to the controlling device 3, as individual countermeasure information, information including the date and applicable area wherein information was inputted and the countermeasures taken in response to that environment, based on the occupant having inputted, from the terminal inputting operating portion 21, information about what the occupant did personally as countermeasures in response to the environment of the applicable area, and about the experience of the occupant, such as the occupant having when a coat, the occupant using a shawl, the conference room being chilly, and the like.

The individual countermeasure information storing portion 31 of the controlling device 3 specifies, from the air-conditioning area information storing portion 14, the air-conditioning equipment corresponding to the applicable area included in the individual countermeasure information, and stores the individual countermeasure information, received from the individual countermeasure information controlling portion 41 of the operating terminal 4, in association with the date of inputting and with the specified air-conditioning equipment.

As with the setting information controlling portion 12′, upon receipt, from a schedule information requesting portion 22 of an operating terminal 2, for setting information of a future date, the setting information controlling portion 32, when providing notification to the operating terminal 4 of the forecasted weather, anticipated outside temperature, and scheduled operating information such as the temperature settings, controlling mode, and the like, with the specified future date, compares the scheduled operating information for a future date to setting information of past dates, and if there exists setting information of a past date wherein at least some of the information matches, then information including at least the temperature settings and the controlling mode, of the setting information of the past date, is sent, as operating information of a past date, in addition to the scheduled operating information of a future date. Then, at the time of that notification, the individual countermeasure information that is stored in the individual countermeasure information storing portion 31 is searched, and if there is individual countermeasure information from a past date, for which operating information has been sent in addition to the scheduled operating information for a future date, that countermeasure to the environment in the individual countermeasure information is sent, further added to the operating information for the past date.

For example, as with the explanation for the example display screen in FIG. 6, if an occupant wishes to check the details of settings for the air-conditioning equipment for the “Fourth Floor, North-East area” for Apr. 1, 2011, and there is a request, to the controlling device 3, from a terminal inputting operating portion 21 of an operating terminal 4 for information specifying the applicable area (Fourth Floor, North-East area) date, then the setting information controlling portion 32′ of the controlling device 3 specifies the air-conditioning equipment corresponding to the Fourth Floor North-East area, from the air-conditioning area information storing portion 14, to obtain, from the setting information storing portion 11, the setting information for April 1 for the specified air-conditioning equipment, and also obtains setting information from past dates (March 29, March 25, . . . ) matching at least some of the scheduled operating information for April 1, such as the temperature settings, the operating mode, or the like, and sends, to the operating terminal 4, information including at least the temperature settings and the operating mode, of the setting information for March 29, March 25, . . . , in a form wherein it is added to the scheduled operating information for the specified date of April 1. At this time the setting information controlling portion 32 searches the individual countermeasure information that is stored in the individual countermeasure information storing portion 31, to check whether or not there is individual countermeasure information for the aforementioned past dates (March 29, March 25, . . . ). Because there is individual countermeasure information for March 29, it is sent to the operating terminal 4, in the form of further adding the countermeasure to the environment in the individual countermeasure information.

FIG. 8 is a diagram illustrating one example of a display screen for setting information for a future date and similar setting information for past dates, sent to the operating terminal 4 in this way.

In this way, through displaying the information as illustrated in FIG. 8, the occupant that is resident in the applicable area of the air-conditioning equipment is not only able to check information for a day in the past wherein the identical settings were performed, in addition to the scheduled operating information for the future date, but is also able to know what countermeasures were taken in response to the environment, performed individually, on the day in the past wherein there were the same settings, thus enabling the occupant to consider the countermeasures that were actually performed on the similar day in the past, making it possible for the occupant to take measures himself/herself after considering the types of countermeasures that will enable one to pass the day in comfort, not only making it possible to maintain the energy conservation effects of the air-conditioning controlling system as a whole, but also possible to further increase the energy conservation awareness of the occupants.

Note that the display screens for the information sent to the operating terminal 2 and 4 in the above examples (FIG. 2, FIG. 4, FIG. 6, and FIG. 8) may be viewed on an information providing system, a PC of an occupant, or the like, that is separate from the air-conditioning system, such as a portal site through a network.

Additionally, while certain examples illustrated a structure wherein when scheduled operating information for a future date, stored in the setting information storing portion 11, is compared to setting information for past dates and there is setting information for a past date wherein at least a portion of the information matches, information including at least the temperature settings and the control mode, in the setting information for that past date, is sent, as operating information for the past date, in addition to the scheduled operation information for the future date, this is not limited to the case of the information matching perfectly, but rather the matching may include also cases wherein the outside temperature or temperature settings are included within a tolerance range that is set with a specific tolerable width.

As described above, in examples of the present invention it is possible to request setting information for the future (scheduled operating information) for the air-conditioning equipment and to request current setting information (current operating information), to thereby check that information, and also possible to know countermeasures taken for the environment, executed individually, and setting information for days in the past wherein similar settings have been made, thus making it possible for the occupant of the applicable area of the air-conditioning equipment to consider by himself/herself clothing to be worn the next day, to take individual countermeasures such as wearing a coat, rather than changing the settings easily, to take individual countermeasures in consideration of countermeasures actually taken and considering the states of days in the past wherein the setting information was similar, making it possible for the individual occupant to take measures considering the type of countermeasure to be taken in order to be comfortable, thus not only making it possible to maintain the energy conservation effects of the air-conditioning controlling system as a whole, but also possible to increase the energy conservation awareness of the occupants.

Note that, for the occupant, there is also the effect of being able to request specific improvements, as necessary, from the building manager of the air-conditioning system, through reviewing the individual countermeasure information.

On the other hand, for the building manager, there is also the effect of being able to compile the statuses of the occupants in order to review the control information and make improvements, and the effect of being able to get a feel for the air-conditioning control that more closely matches that of the occupants, and of being able to more easily run energy conservation activities performed by the building as a whole. Moreover, not only can one anticipate the effects of providing a comfortable environment to the occupants, but also of providing the appeal of being a building wherein air-conditioning control has arrived, a building that has achieved energy conservation, making it possible to increase the level of satisfaction of the occupants.

Note that the various examples set forth above can be combined freely within the scope of the invention, or any given structural element within any of the examples may be modified or any given structural element may be omitted in any of the examples, within the scope of the present invention.

1. An air-conditioning controlling system comprising:
a controlling device controlling the operation of air-conditioning equipment based on setting information that is set up in advance,
an operating terminal configured to change setting information in an applicable area of the air-conditioning equipment,
a communication circuit connecting the operating terminal to the controlling device,
wherein the operating terminal comprises:
a schedule information requesting portion requesting, from the controlling device, setting information for a specified future date set for the air-conditioning equipment of the applicable area through specifying the applicable area and the future date; and
wherein the controlling device comprises:
a setting information controlling portion which, upon receipt of a request for setting information for a future date from the schedule information requesting portion of an operating terminal, specifies the air-conditioning equipment corresponding to the specified applicable area, and sends, to the operating terminal, the forecasted weather and anticipated outside temperature on the specified future date and, as scheduled operating information, at least the temperature settings and the controlling mode from the setting information that is set for the specified future date for the specified air-conditioning equipment.

2. The air-conditioning controlling system as set forth in claim 1, wherein the operating terminal further comprises:
a current information requesting portion requesting, from the controlling device, current setting information for the air-conditioning equipment for the applicable area, through an occupant specifying the applicable area; and
wherein the controlling device further comprises:
an operating information controlling portion specifying the air-conditioning equipment corresponding to the specified applicable area upon receipt of a request for current setting information from a current information requesting portion of the operating terminal, and sending, to the operating terminal, at least the current operating state and the type of operation for the specified air-conditioning equipment, as current operating information, together with the current weather and outside temperature.

3. The air-conditioning controlling system as set forth in claim 1 wherein: when sending the scheduled operating information to the operating terminal, the setting information controlling portion of the controlling device, upon receipt of a request for setting information for a future date from a schedule information requesting portion of an operating terminal, compares the scheduled operating information for the future date to setting information for past dates, and if there exists setting information for a past date that matches, at least in part, information included in the scheduled operating information, adds, to the scheduled operating information for the future date, information including at least the temperature settings and the controlling mode included in the setting information for the past date, as operating information for the past date.

4. The air-conditioning controlling system as set forth in claim 3, wherein the operating terminal further comprises:
an individual countermeasure information controlling portion sending to the controlling device, as individual countermeasure information, information including a date of inputting, an applicable area, and a countermeasure in response to the environment through the occupant inputting an applicable area and a countermeasure in response to the environment taken individually in the applicable area; and
wherein the controlling device further comprises:
an individual countermeasure information storing portion specifying the air-conditioning equipment corresponding to the applicable area included in the individual countermeasure information and storing the individual countermeasure information in relation to the specified air-conditioning equipment when individual countermeasure information has been received from the individual countermeasure information controlling portion of an operating terminal;
wherein when the setting information controlling portion sends operating information for a past date to the operating terminal, the setting information controlling portion searches the individual countermeasure information stored in the individual countermeasure information storing portion, and if individual countermeasure information exists for the air-conditioning equipment of the applicable area on a past date, further adds, to the operating information for the past date, the countermeasure for the environment in that individual countermeasure information.
